(19) United States
(12) Patent Application Publication
(10) Pub. No.: US 2006/0213264 A1
(43) Pub. Date: Sep. 28, 2006

(54) Dewing sensor

(75) Inventors: Shih-Wei Ku, Kaohsiung City (TW); Ching-Hao Chung, Fongshan City (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 11/194,677

(22) Filed: Aug. 2, 2005

(30) Foreign Application Priority Data
Mar. 25, 2005 (TW) 094109322

(51) Int. Cl. G01N 1/00

(52) U.S. Cl. 73/335.03

(57) ABSTRACT

A dewing sensor and a method for making the dewing sensor. The dewing sensor includes a substrate having at least two electrodes, at least two comb electrodes, and a detecting layer, wherein the comb electrodes contact the two electrodes on the substrate, and the detecting layer includes a derivative of cellulose formed on the comb electrodes.

### BACKGROUND OF THE INVENTION

1. Field of the Invention

The present invention generally relates to a dewing sensor and, more particularly, to a dewing sensor with a detecting layer made of cellulose derivatives.

2. Description of the Related Art

In the agriculture, textile, aerospace, and power industries, the standard of quality requirement is rapidly getting stricter, and thus the control of the temperature and humidity of working environments and monitoring the ingredient of industrial water have become industrial standards. Humidity is the quantity of water vapor in unit volume of air. For certain manufacturing processes, a preferred humidity should be controlled between 0-20% RH. When the humidity rises to 20% RH and above, medicines, foods, and semiconducting materials start to deteriorate. When the humidity is 35% RH, metals and electronic devices begin to oxidize and deteriorate. When the humidity is 60% RH, photographic and optical instruments, paper, and textile products start to become moldy. Therefore, the control of the humidity is an important technology in manufacturing processes.

A conventional humidity meter has a substrate coated with a humidity detecting material to form a humidity detecting film. The humidity meter is a humidity sensitive device because the impedance and dielectric constants of the humidity detecting film rapidly change according to the quantity of the vapor in the air adsorbed on the humidity detecting film. The theory of humidity sensitive device described above is capable of being used in a dewing sensor to detect vapor saturation at room temperature.

Conventionally, for preventing electric devices from dewing and short circuits resulted from water cooling systems therein, the electric devices further include dewing sensors to detect the vapor saturation and send a feedback control signal to drive exsiccators. The characteristic curves of the conventional dewing sensors, however, are too smooth to detect the dewing reaction when the humidity is between 89˜90% RH. Furthermore, because of the high cost of the conventional dewing sensors made of metallic oxides by integrated circuit process, the conventional dewing sensors are not extensively used in some low-cost electrical devices.

### BRIEF SUMMARY OF THE INVENTION

Hydroxyethyl cellulose (HEC), a cellulose derivative with good capabilities in thickening, emulsifiability, suspension, dispersion, retaining water, and preventing erosion and corrosion, is a cellulose polymer non-ionic surfactant. In the present invention, a dewing sensor in an electric device is made of hydroxyethyl cellulose (HEC) by a simple manufacturing process.

The present invention provides a dewing sensor including a substrate having at least two electrodes, at least two comb electrodes, and a detecting layer, wherein the comb electrodes contact the two electrodes on the substrate, and the detecting layer includes a cellulose derivative formed on the comb electrodes.

The present invention further provides a method for making a dewing sensor. The method for making a dewing sensor includes steps of (a) providing a substrate having at least two electrodes, a conductive adhesive, and a detecting adhesive, (b) coating the substrate with the conductive adhesive to form at least two comb electrodes contacting the two electrodes on the substrate; and (c) coating the comb electrodes with the detecting adhesive, wherein the detecting adhesive comprises a cellulose derivative and carbon.

The substrate may be made of ceramic, bakelite, or fiberglass plates, wherein the substrate is preferred to be a ceramic plate with a pair of electrodes. The comb electrodes disposed on the substrate may be made of any conductive material including gold, silver, and carbon, wherein the comb electrodes are preferred to be made of carbon. The detecting layer may be made of hydroxyethyl cellulose (HEC), and the proper content of hydroxyethyl cellulose (HEC) is 5-15% of the detecting layer. The detecting layer further includes carbon, wherein the proper content of carbon is 5-15% of the detecting layer.

In the step (b) of the method for making a dewing sensor in the present invention, the coating step may be a screen print process. The method for making a dewing sensor further includes a step (b1) to dry the substrate by heat between the steps (b) and (c) such that the conductive adhesive can be fixed on the substrate. The method for making a dewing sensor further includes a step (c1) to dry the substrate after step (c).

Additional features and advantages of the present invention will be set forth in part in the description which follows, and in part will be obvious from the description, or may be learned by practice of the present invention. The features and advantages of the present invention will be realized and attained by means of the elements and combinations particularly pointed out in the appended claims.

It is to be understood that both the foregoing general description and the following detailed description are exemplary and explanatory only and are not restrictive of the present invention, as claimed.

The accompanying drawings, which are incorporated in and constitute a part of this specification, illustrate several embodiments of the present invention and together with the description, serve to explain the principles of the present invention.

### BRIEF DESCRIPTION OF THE DRAWINGS

FIG. 1 is a top view of a dewing sensor in an embodiment of the present invention;

FIG. 2 is a characteristic curve of the embodiment of the present invention showing a relation between the output voltage of the dewing sensor in the embodiment and the humidity.

### DESCRIPTION OF THE EMBODIMENTS

Reference will now be made in detail to present embodiments of the present invention, examples of which are illustrated in the accompanying drawings. Wherever possible, the same reference numbers will be used throughout the drawings to refer to the same or like parts.

### Embodiment 1

A process of making hydroxyethyl cellulose includes steps of adding sodium hydroxide in cellulose materials to form alkalized cellulose, and adding oxyacetylene in the alkalized cellulose to form the non-ionic surfactant, hydroxyethyl cellulose (HEC).

In view of mixing the carbon powder and the HEC, a series of SFG-75 (Switzerland) is used in making the carbon black for the dewing sensor in the present embodiment, wherein the quantity content of the carbon and HEC may be modified according to a dilatability of the detecting layer and the impedance of the dewing sensor.

In a process of making carbon adhesive which is used in the print process for thickening a film of a variable resistor, the series of SFG-75 (Switzerland) and methyl are added in a bakelite material which is suitable for PCB plates to be mixed and condensed.

In a process of making the detecting adhesive, the HEC (5-15%) and carbon black (5-15%) are mixed in water.

### Embodiment 2

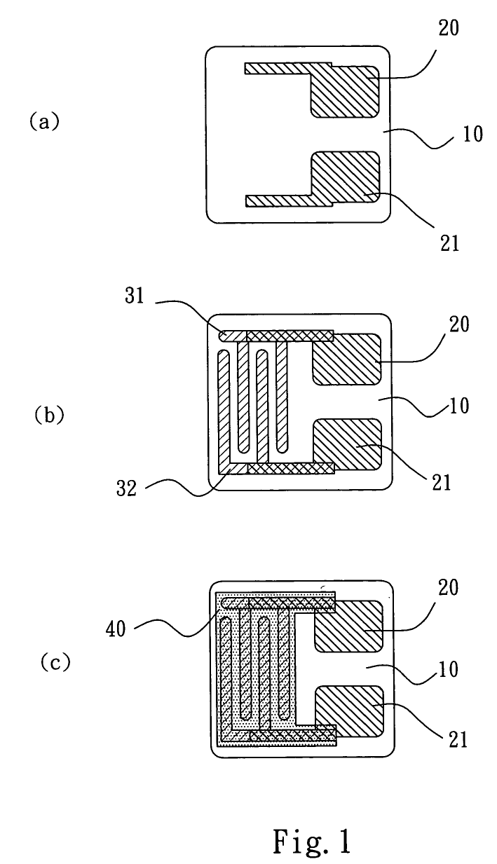

As shown in FIG. 1a, two silver electrodes 20, 21 are screen printed (halftone No.: #100-#250) on a ceramic substrate 10 made of Al₂O₃. The ceramic substrate 10 is screen printed with the carbon adhesive to form a pair of comb electrodes 31, 32 connecting the electrodes 20, 21, as shown in FIG. 1b. After drying the ceramic substrate 10 at 180° C. for 5 minutes, the comb electrodes 31, 32 are coated with a detective adhesive by screen printing. Finally, after drying the substrate 10 at 200° C. for 5 minutes, the dewing sensor, as shown in FIG. 1c, is finished.

In the present embodiment, the screen printing process is capable of increasing the contacting area and the adhesion between the detecting adhesive and the substrate.

The terms of the screen printing process include that (A) the halftone should be cleaned once after per 50 prints, (B) the tension of the halftone is 34 Kg/cm², (C) the printing speed is 30 cm/s, and (D) the printing interval is 0.6 mm.

### Embodiment 3

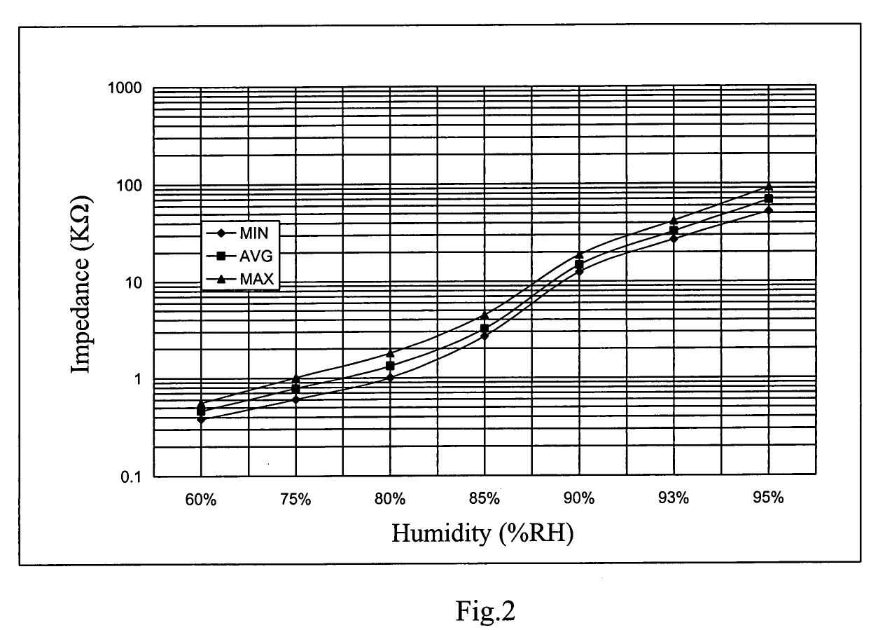

For detecting the humidity, the two electrodes of the dewing sensor are fastened by a clamping apparatus and connecting a multimeter, and the temperature and humidity are determined by a standard temperate-humidity controller. After stabilizing the dewing sensor, the impedance between the electrodes of the dewing sensor is output. Moreover, a saturated salt solution is used as a simple method to generate the humidity according to Japan industrial standard (JIS B7920) which mentions that different concentrations of salt solutions shall have different humidities at the same temperature. The detected result is shown in FIG. 2.

FIG. 2 shows the result detected at 25° C., wherein MIN, AVG, and MAX are the impedance between the two electrodes of the dewing sensor. The standard temperate-humidity controller initiates the temperature at 25° C. The two electrodes of the dewing sensor are fastened by a clamping apparatus and connect the multimeter via a conducting wire to detect humidity. The values of the impedance of ten dewing sensors are respectively measured when the humidity is 60%, 75%, 80%, 90%, 93%, or 95%, and three of the impedance of the dewing sensors at one humidity are respectively defined as MIN, AVG, and MAX, as shown in FIG. 2.

When the humidity is 80-90% RH, the values of impedance rise to show the active point of the detecting material of the dewing sensor. As a result of the distensibility of the humidity detecting adhesive after being dampened, the impedance is increased. Moreover, the rising characteristic curve of the impedance is an n exponential curve.

Other embodiments of the present invention will be apparent to those skilled in the art from consideration of the specification and practice of the present invention disclosed herein. It is intended that the specification and examples be considered as exemplary only, with a true scope and spirit of the present invention being indicated by the following claims.

What is claimed is:

1. A dewing sensor comprising:
a substrate having at least two electrodes;
at least two comb electrodes; and
a detecting layer, wherein the comb electrodes contact the two electrodes on the substrate, and the detecting layer includes a cellulose derivative formed on the comb electrodes.

2. The dewing sensor of claim 1, wherein the substrate is a ceramic substrate.

3. The dewing sensor of claim 1, wherein the comb electrodes comprise carbon.

4. The dewing sensor of claim 1, wherein the cellulose derivative of the detecting layer is hydroxyethyl cellulose (HEC).

5. The dewing sensor of claim 4, wherein the detecting layer consists of 5-15% hydroxyethyl cellulose.

6. The dewing sensor of claim 1, wherein the detecting layer further comprises carbon.

7. The dewing sensor of claim 6, wherein the detecting layer consists of 5-15% carbon.

8. A method for making a dewing sensor, comprising:
(a) providing a substrate having at least two electrodes, a conductive adhesive, and a detecting adhesive;
(b) coating the substrate with the conductive adhesive to form at least two comb electrodes contacting the two electrodes on the substrate; and
(c) coating the comb electrodes with the detecting adhesive, wherein the detecting adhesive comprises a cellulose derivative and carbon.

9. The method for making a dewing sensor of claim 8, wherein the substrate is a ceramic substrate.

10. The method for making a dewing sensor of claim 8, wherein the cellulose derivative is hydroxyethyl cellulose (HEC).

11. The method for making a dewing sensor of claim 10, wherein the detecting adhesive consists of 5-15% hydroxyethyl cellulose.

12. The method for making a dewing sensor of claim 8, wherein the detecting adhesive consists of 5-15% carbon.

13. The method for making a dewing sensor of claim 8, wherein, in step (b), the substrate is coated with conductive adhesive by screen printing.

14. The method for making a dewing sensor of claim 8 further comprising a step (b1) to dry the substrate between the steps (b) and (c).

15. The method for making a dewing sensor of claim 8 further comprising a step (c1) to dry the substrate after step (c).
